(19) United States
(12) Patent Application Publication
(10) Pub. No.: US 2022/0181092 A1
(43) Pub. Date: Jun. 9, 2022

(54) A Process of Integrating Electrically Conductive Nanoparticulate Material into an Electrically Conductive Cross-Linked Polymer Membrane

(71) Applicant: SUPERDIELECTRICS LTD, Cambridge (GB)

(72) Inventor: Donald James Highgate, Cambridge (GB)

(21) Appl. No.: 17/594,175

(22) PCT Filed: Apr. 7, 2020
(86) PCT No.: PCT/GB2020/050910

§ 371 Date: Oct. 5, 2021

(30) Foreign Application Priority Data
Apr. 10, 2019 (GB) 1905107.7

(51) Int. Cl. H01G 11/48; H01G 11/36; H01G 11/24; H01G 11/46; H01G 11/26; H01G 11/38; H01G 11/86; C08F 226/10; B05D 1/18

(52) U.S. Cl. CPC H01G 11/48; H01G 11/36; H01G 11/24; H01G 11/46; B05D 2201/02; H01G 11/38; H01G 11/86; C08F 226/10; B05D 1/18; H01G 11/26

(57) ABSTRACT

Disclosed herein is a process of integrating electrically conductive nanoparticulate material into a surface layer of an electrically conductive cross-linked polymer, comprising the steps of: immersing an electrically conductive cross-linked polymer in a first medium; and subsequently immersing the electrically conductive cross-linked polymer in a second medium; wherein the first medium comprises an electrically conductive nanoparticulate material dispersed in a non-aqueous polar liquid, and the second medium comprises an aqueous liquid.

### FIELD OF THE INVENTION

The present invention relates to integrated polymer materials, and their use as a component in supercapacitors.

### BACKGROUND OF THE INVENTION

Conventional capacitors offer a means of storing electrical energy. Generally, conventional capacitors are composed of a pair of electrically conducting plates (which thereby act as a pair of electrodes), separated by a dielectric material. The dielectric material generally has low conductivity but can be polarized by an electric field. As such, when the electrodes experience a potential difference, an electric field develops across the dielectric material, allowing electrical energy to be stored. However, the maximum capacitance values achieved by conventional capacitors are such that the electrical energy storage capacity is generally lower than that of electrochemical batteries.

Meanwhile, supercapacitors achieve significantly higher capacitance values compared to conventional capacitors, and so offer an increased energy storage capacity. Supercapacitors are generally composed of two electrodes and an electrolyte component located therebetween. The electrolyte component is generally ionically conductive (which therefore contrasts with the nature of the dielectric component of conventional capacitors, which as mentioned is generally of low conductivity). Within a supercapacitor, electrical energy is stored mainly by way of two principles: electrostatic capacitance (due to the charge distribution within the electrolyte component), and electrochemical capacitance (due to electrical energy from reversible oxidation-reduction (redox) reaction between the electrolyte and the electrodes); within a supercapacitor, energy may be stored by way of one or both of these two principles. There are multiple different kinds of supercapacitor systems, including double-layer supercapacitors, pseudo-capacitive supercapacitors, and hybrid supercapacitors. Double-layer supercapacitors typically comprise carbon electrodes that are of comparatively low cost. The capacitance of double-layer supercapacitors is largely electrostatic capacitance. Meanwhile, pseudo-capacitive supercapacitors comprise comparatively higher cost electrodes that are capable of undergoing a redox reaction together with the electrolyte. Such redox active electrodes can comprise, for example, ruthenium or vanadium. The capacitance of pseudo-capacitive supercapacitors is therefore increased (or augmented) by electrochemical capacitance. Hybrid supercapacitors comprise a combination of electrodes with differing characteristics, and can for example comprise one carbon electrode and one electrode capable of undergoing a redox reaction with the electrolyte. The capacitance of hybrid supercapacitors is therefore a combination of electrostatic capacitance and electrochemical capacitance.

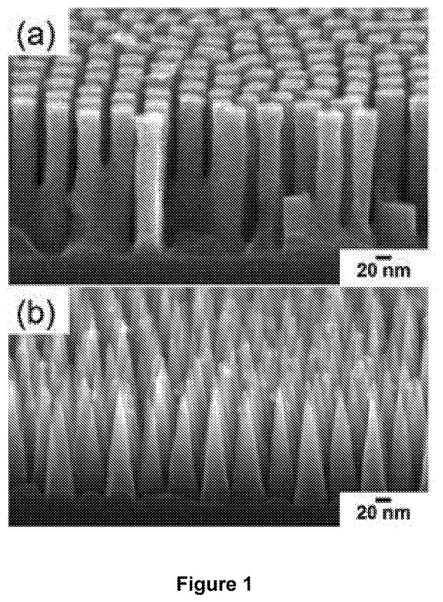

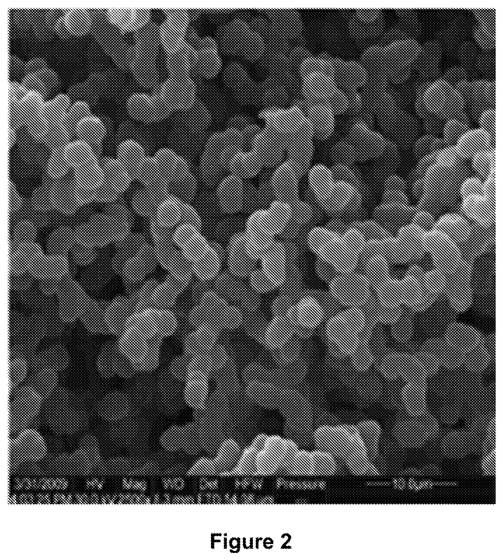

Increasing capacitance (and so the energy storage capacity) of a supercapacitor is desirable. The maximum capacitance value achieved by a supercapacitor may depend on the nature of the electrolyte and the nature of the electrodes. For example, technologies exist to increase the effective surface area of each electrode plate which directly increases capacitance, and this represents the most recent improvement in supercapacitor performance. The development of electrodes having very large effective areas has been achieved, for example, by the development of nano-structures grown or deposited on the electrode surface—such “extended surface” electrodes therefore have increased surface area compared to smooth electrodes. Typical examples are shown in FIG. 1, consisting of regular arrays of nano rods, or in FIG. 2, consisting of irregular structures based on carbon micro-particles. However, there are various shortcomings associated with extended surface electrodes. For instance, challenges exist with the manufacturing of electrodes with extended surface areas compared with simple “smooth surface” electrodes, as well as their assembly with the electrolyte. Further, in order to realise the full potential of the additional area provided by extended surface electrodes, only an electrolyte that is able to penetrate the nano-/micro-structure of the extended electrode surface can be used. This restricts use to conventional supercapacitor electrolytes, i.e. those that are liquid, and whilst gelatinous electrolytes may be used, the properties of these must be such that they do not exhibit a yield stress that would prevent penetration of the extended electrode surface. This therefore precludes the use of more advanced options for the electrolyte component when using extended surface electrodes. For instance, WO2017/153705, WO2017/153706, and WO2017/115064 teach the production of electrically conducting cross-linked hydrophilic polymers which can be used in place of a conventional liquid electrolyte in a supercapacitor. These materials have favourable electrical properties, but, being solid, are not suitable for penetrating the nano-/micro-structure of an extended electrode surface, and so cannot realise the full potential of such extended surfaces.

In summary there remains a need for improved technologies for increasing capacitance.

### SUMMARY OF THE INVENTION

A new and surprising means by which to increase capacitance is provided herein. This is achieved by way of a new “integrated” polymer structure, provided by the integration of electrically conductive nanoparticulate material within a surface layer of an electrically conductive cross-linked polymer.

This “integrated” polymer, when included as the electrolyte component of a supercapacitor, enables increased capacitance, thereby improving energy storage capacity. Without wishing to be bound by theory, it is thought that when the integrated polymer contacts the electrode surface, an increased effective surface area at the electrolyte/electrode interface is provided, achieved by the electrically conductive nanoparticulate material integrated within the polymer's surface layer. This increase in effective surface area is provided without the necessity for an extended surface electrode, thereby allowing simple smooth surface electrodes to be used.

In a first aspect, there is a process of integrating electrically conductive nanoparticulate material into a surface layer of an electrically conductive cross-linked polymer, comprising the steps of:

immersing an electrically conductive cross-linked polymer in a first medium, and

subsequently immersing the electrically conductive cross-linked polymer in a second medium; wherein

the first medium comprises an electrically conductive nanoparticulate material dispersed in a non-aqueous polar liquid, and

the second medium comprises an aqueous liquid.

The process according to the first aspect is a surprisingly effective way to achieve the integrated polymer. Without wishing to be bound by theory, it is thought that the immersion in the first medium results in the expansion of the polymer lattice, allowing the electrically conductive nanoparticulate material to penetrate a surface layer of the polymer structure. Then, the subsequent immersion step in the second medium contracts the polymer lattice, thereby trapping the nanoparticulate material in the surface layer of the polymer. The nanoparticulate material is integrated in the surface layer such that it does not leach out/rub off, representing an improvement over merely “dip-coating” the polymer in particulate material.

In a second aspect, there is a process of forming a supercapacitor, comprising the steps of

integrating electrically conductive nanoparticulate material into a surface layer of an electrically conductive cross-linked polymer using the process of the first aspect; and

positioning the polymer between two electrodes.

In a third aspect, there is an electrically conductive cross-linked polymer containing an electrically conductive nanoparticulate material integrated in a surface layer. This polymer is obtainable by the process according to the first aspect.

In a fourth aspect, there is the use of a polymer according to the third aspect in a supercapacitor.

In a fifth aspect, there is a supercapacitor comprising two electrodes and a polymer according to the third aspect located therebetween.

### DETAILED DESCRIPTION

The polymer used in the process disclosed herein is capable of functioning as the electrolyte component in a supercapacitor. As such the polymer used in the process disclosed herein is electrically conductive. As used herein, the term “electrically conductive” takes its usual definition in the art, and so can encompass materials that are electronically conductive and/or ionically conductive, i.e. materials that employ some form of electron and/or ionic mobility.

As used herein, the term “electronically conductive” takes its usual definition in the art, and refers to a material in which there is some form of electron mobility, such that the conduction process is principally dependent upon electron transfer, or in which an electron is yielded as an output at an interface.

As used herein, the term “ionically conductive” takes its usual definition in the art, and refers to a material in which there is some form of ionic mobility, such that the conduction process is principally dependent on ion transfer.

As used herein, the term “polymer” takes its usual definition in the art and so refers to a homopolymer or a copolymer formed from the polymerisation of one or more monomers. As used herein, the term “homopolymer” takes its usual definition in the art, and so refers to a polymer whose polymer chains comprise one type of monomer. As used herein, the term “co-polymer” takes its usual definition in the art, and so refers to a polymer whose polymer chains comprise two or more different types of monomers. As used herein, the term “monomer” takes its usual definition in the art, and so refers to a molecular compound that may chemically bind to another monomer to form a polymer.

The electrically conductive cross-linked polymer used in the process disclosed herein is preferably a hydrophilic polymer. As used herein, the term “hydrophilic polymer” refers to a polymer that dissolves in water when it is not cross-linked and absorbs water and swells to form a stable elastic solid when cross-linked. Hydrophilic polymers possess certain benefits due to their water properties.

As used herein, the term “hydrophilic monomer” takes its usual definition in the art, and so refers to a monomer with an affinity for water molecules. The term “hydrophobic monomer” also takes its usual definition in the art, and so refers to a monomer that repels water molecules.

As used herein, the term “cross-linker” refers to molecular compound capable of forming chemical bonds between polymer chains. A polymer that includes such chemical bonds between its chains is referred to as a “cross-linked” polymer.

The electrically conductive cross-linked polymer used in the process disclosed herein need not be limited to a particular shape, but generally the polymer comprises a top surface, a bottom surface, and a number of wall-like sides (typically four). Typically, the polymer approximates to a substantially 3D planar shape. Generally, the thickness of the polymer (i.e. the distance between the top surface and the bottom surface) is in the range of 250 μm to 2 mm. Disclosed herein, the electrically conductive nanoparticulate material is integrated into a surface layer of the electrically conductive cross-linked polymer. This allows the integrated nanoparticulate material to form part of the electrolyte/electrode interface when the integrated polymer is positioned between two electrodes and used as the electrolyte component in a supercapacitor. The term “surface layer” refers to an outer-most region of polymer, typically an outer-most region having a thickness of 80-120 μm, preferably 90-110 μm. Disclosed herein, the nanoparticulate material may be integrated into the top surface layer (i.e. the outer-most top layer) and/or the bottom surface layer (i.e. the outer-most bottom layer) of the polymer.

Preferably, the nanoparticulate material is integrated into both of the top surface layer and the bottom surface layer. It will be understood that generally, the nanoparticulate material is integrated solely into a surface layer of the polymer, rather than being incorporated throughout the entirety of the polymer. This results in a polymer where the nanoparticulate material is integrated into a surface layer, with the remaining regions of the polymer being substantially free from nanoparticulate material.

As used herein, the term “nanoparticulate material” refers to a material provided as a plurality of particles with dimensions small enough to fall in the nm range (rather than in the pm range) and so have dimensions of less than 1000 nm, more specifically dimensions of 1-1000 nm. Preferably, the nanoparticulate material is provided as a plurality of particles with dimensions of less than 800 nm, more preferably less than 600 nm. The nanoparticulate material may be provided as a plurality of particles with dimensions of more than 1 nm, more than 10 nm, or more than 50 nm. The skilled person will be familiar with the techniques necessary to measure the relevant dimensions of the particles of the nanoparticulate material, e.g. by way of image analysis, whereby particles flow through a capillary tube, and are scanned by an image analyser to measure the relevant dimensions, a suitable apparatus being the Sysmex FPIA-3000 Flow Particle Image Analyzer.

The shape of the nanoparticulate material may be defined by way of the aspect ratio, where the aspect ratio is defined as the largest dimension divided by the smallest orthogonal dimension (which for tube-like particles therefore equates to length divided by diameter). The higher the aspect ratio, the more elongate the particle, the lower the aspect ratio, the more spherical the particle.

It is thought that by tailoring the aspect ratio, the nanoparticulate material is taken up particularly effectively into the polymer lattice. The nanoparticulate material may consist of particles with an aspect ratio of less than 100:1, preferably less than 50:1, more preferably less than 10:1. The nanoparticulate material may consist of particles with an aspect ratio of at least 2:1, preferably at least 3:1. In a particularly preferred embodiment, the nanoparticulate material consists of particles with an aspect ratio between 3:1 and 10:1. With regards to measuring the aspect ratio, the skilled person will (as stated above) be familiar with how to measure the relevant dimensions of the nanoparticulate material, e.g. by way of image analysis, whereby particles flow through a capillary tube, and are scanned by an image analyser to measure the relevant dimensions of the particles, a suitable apparatus being the Sysmex FPIA-3000 Flow Particle Image Analyzer. By this method the largest dimension and the smallest orthogonal dimension are measured, and these are then used to calculate the aspect ratio.

The nanoparticulate material may be provided as a plurality of particles whose mass median diameter is less than 1000 nm, preferably less than 800 nm, more preferably less than 600 nm. The nanoparticulate material may be provided as a plurality of particles whose mass median diameter is more than 1 nm, more than 10 nm, or more than 50 nm. The skilled person will be familiar with how to measure the mass median diameter, for instance by laser diffraction by way of a Malvern-Panalytical ‘Zetasizer’.

The electrically conductive nature of the nanoparticulate material is such that when the integrated polymer is used as the electrolyte component of a supercapacitor and contacts an electrode surface, an extended effective surface area at the electrolyte/electrode interface is provided. The nanoparticulate material may therefore be any appropriate electrically conductive material, particularly those materials that are otherwise used to form electrode components—the skilled person will be familiar with such materials. For example, the electrically conductive nanoparticulate material can be electrically conductive carbon, a transition metal oxide, or combinations thereof. Such materials are otherwise used to form electrodes, and therefore such materials are particularly effective in forming the extended electrolyte/electrode interface afforded by the integrated polymer disclosed herein. The term “transition metal oxide” refers to the oxide of a metal that features in the d-block (i.e. from group 3 to group 12) of the periodic table. The transition metal oxide may be MnO, MnO₂, NaMnO₂; ZnO₂; Fe₂O₃; MoS₂, V₂O₅, RuO₂, IrO₂, or combinations thereof. Preferably, the transition metal oxide is MnO₂, MnO, ZnO₂, NaMnO₂, Fe₂O₃, or MoS₂.

Preferably, the electrically conductive nanoparticulate material is electrically conductive carbon. The skilled person will be familiar with the forms of carbon that are electrically conductive. For example, the electrically conductive carbon can be in the form of activated carbon powder, powdered graphite, powdered graphene, powdered graphane, powdered carbon nanotubes, or combinations thereof. Preferably, the electrically conductive carbon is in the form of activated carbon powder, powdered graphite, powdered graphene, powdered graphane, or combinations thereof.

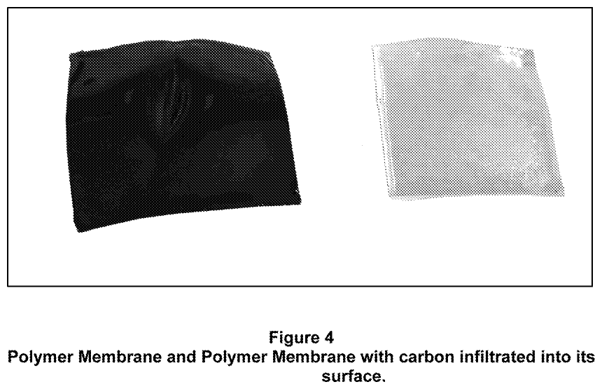

FIG. 4 shows a photograph of an electrically conductive cross-linked polymer both before (on the right) and after (on the left) being subjected to the integration of electrically conductive nanoparticulate material in its surface layer. It can be seen that the polymer is rendered “opaque” by the integrated nanoparticles, which in the instance of FIG. 4 were in the form of electrically conductive carbon.

The electrically conductive cross-linked polymer can be electronically conductive and/or ionically conductive. Preferably, the electrically conductive cross-linked polymer is electronically conductive.

The electrically conductive cross-linked polymer is generally formed by polymerising a polymerisation mixture. As used herein, the term “polymerisation mixture” refers to a solution or dispersion of polymer-forming components. The mixture is generally homogenous, meaning that the polymer-forming components are uniformly dissolved or mixed. The electrically conductive cross-linked polymer is fully formed prior to being subjected to the steps that integrate the electrically conductive nanoparticulate material in a surface layer.

Preferably, the electrically conductive cross-linked polymer is formed by polymerising a polymerisation mixture, the polymerisation mixture comprising at least one hydrophobic monomer, at least one hydrophilic monomer, at least one cross-linker, the polymerisation mixture further comprising one or the other of; at least one electronically conductive polymer, or at least one amino acid. The resulting polymer is electronically conductive. The resulting polymer has particularly good water properties (i.e. good properties/behaviour in relation to water and other aqueous environments), and performs particularly well when used as the electrolyte component in a supercapacitor. Details of these polymers are disclosed in WO2017/153705 and WO2017/115064.

As mentioned above, the polymerisation mixture can comprise at least one hydrophobic monomer. The polymerisation mixture may comprise one hydrophobic monomer.

Preferably, the at least one hydrophobic monomer is selected from methyl methacrylate, allyl methacrylate, acrylonitrile, methacryloxypropyltris(trimethylsiloxy)silane, 2,2,2-trifluoroethyl methacrylate, or a combination thereof. More preferably, the at least one hydrophobic monomer is selected from acrylonitrile and methyl methacrylate, or a combination thereof.

As mentioned above, the polymerisation mixture can comprise at least one hydrophilic monomer. Thee polymerisation mixture may comprise one hydrophilic monomer.

Preferably, the at least one hydrophilic monomer is selected from methacrylic acid, 2-hydroxyethyl methacrylate, ethyl acrylate, vinyl pyrrolidone, propenoic acid methyl ester, monomethacryloyloxyethyl phthalate, ammonium sulphatoethyl methacrylate, poly vinyl alcohol or a combination thereof. More preferably, the at least one hydrophilic monomer is selected from 1-vinyl-2-pyrrolidone (VP) and 2-hydroxyethyl methacrylate, or a combination thereof. The at least one cross-linker can be methylenebisacrylamide, N-(1-Hydroxy-2,2-dimethoxyethyl)acrylamide, allyl methacrylate and ethylene glycol dimethacrylate. Preferably, the cross-linker allyl methacrylate and ethylene glycol dimethacrylate. The cross-linker may be hydrophobic or hydrophilic.

It will be appreciated from the definitions above, that the terms “hydrophobic monomer” and “cross-linker” are not necessarily mutually exclusive. Disclosed herein, the hydrophobic monomer and the cross-linker may be the same or different. The hydrophobic monomer may, in certain embodiments, be the same as the cross-linker. For example, in certain embodiments, both the cross-linker and the hydrophobic monomer are allyl methacrylate. In other embodiments, the hydrophobic monomer is non-cross-linking, and in such embodiments, the cross-linker and the hydrophobic monomer are different chemical species. Preferably, the hydrophobic monomer is a different chemical species to the cross-linker. Generally, the hydrophilic monomer is a different chemical species to both the cross-linker and the hydrophobic monomer.

Preferably, the polymerisation is carried out by thermal, UV or gamma radiation. More preferably, the polymerisation step is carried out by UV or gamma radiation. As the skilled person will appreciate, UV or gamma radiation may be carried out under ambient temperature and pressure, whilst thermal polymerisation may be carried out at temperatures up to 70° C.

In a preferred embodiment, the polymerisation mixture further comprises a polymerisation initiator. The polymerisation initiator may be azobisisobutyronitrile (AIBN) or 2-hydroxy-2-methylpriophenone. The presence of a polymerisation initiator is particularly preferred when the polymerisation is by thermal or UV radiation. In one embodiment, the polymerisation is by thermal means and the initiator is azobisisobutyronitrile (AIBN). In another embodiment, the polymerisation is by UV radiation and the initiator is 2-hydroxy-2-methylpriophenone.

In one embodiment, the electrically conductive cross-linked polymer is formed by polymerising a polymerisation mixture, the polymerisation mixture comprising at least one hydrophobic monomer, at least one hydrophilic monomer, at least one electronically conductive polymer, and at least one cross-linker. The resulting polymer is electronically conductive. The resulting polymer has particularly good water properties, excellent mechanical properties, excellent electrical conductivity, and provides particularly high capacitance values.

Preferably, the at least one electronically conductive polymer is selected from polyethylenedioxythiophene:polystyrene sulphonate, polypyrrole, polyaniline, polyacetylene, or a combination thereof. More preferably, the intrinsically electronically active material is polyethylenedioxythiophene:polystyrene sulphonate (PEDOT:PSS).

In one embodiment, the electrically conductive cross-linked polymer is formed by polymerising a polymerisation mixture, the polymerisation mixture comprising at least one hydrophobic monomer, at least one hydrophilic monomer, at least one amino acid, and at least one cross-linker. The resulting polymer is electronically conductive, which is thought to be due to the electron conjugation within the aromatic system/the delocalised electron lone pairs in the amino acid favourably altering the electronic properties of the polymer material. As used herein, the term “amino acid” takes its usual definition in the art, and so refers to an organic compound with amino and carboxylic acid functional groups, and a side-chain that is specific to each amino acid. The term encompasses traditional “natural” amino acids but also any compound with an amino acid backbone (i.e. with any side-chain). Preferably, the amino acid (preferably a natural amino acid) comprises, in its side chain, an aromatic group.

In one embodiment, the at least one amino acid is selected from phenylalanine, tryptophan, histidine, ethylenediaminetetraacetic acid (EDTA) and tyrosine, or a combination thereof. Preferably, the at least one amino acid is selected from phenylalanine, tryptophan, histidine and tyrosine or a combination thereof. Still more preferably, the at least one amino acid is selected from phenylalanine and tryptophan, or a combination thereof.

In the process disclosed herein, there is the step of immersing the electrically conductive cross-linked polymer in a first medium, and subsequently immersing the electrically conductive cross-linked polymer in a second medium. The polymer is immersed in each medium such that at least one of the top surface or the bottom surface of the polymer is submerged in, and exposed to, each medium, but preferably such that both of the top surface and the bottom surface is submerged in, and exposed to, each medium. Therefore, as the skilled person will appreciate the term “immersing” can refer to partially or fully submerging the polymer in each respective medium, but preferably refers to fully submerging the polymer in each medium.

It is thought that immersion in the first medium expands the polymer lattice allowing the electrically conductive nanoparticulate material to penetrate the polymer surface layer. Preferably, the electrically conductive cross-linked polymer is immersed in the first medium for a period of at least 30 seconds, more preferably at least 2 minutes, more preferably at least 15 minutes, more preferably at least 30 minutes. Immersing for such time periods allows for good uptake of the electrically conductive nanoparticulate material.

In the process disclosed herein, after the step of immersing the electrically conductive cross-linked polymer in the first medium, the polymer is removed from the first medium and then subsequently immersed in a second medium, thereby arriving at a polymer which has electrically conductive nanoparticulate material integrated into a surface layer. It is thought that, having expanded the polymer lattice by immersion in the first medium, immersion in the second medium then contracts the polymer lattice, thereby trapping the electrically conductive nanoparticulate material in a surface layer (or surface layers) of the polymer. The period of immersion in the second medium can be tailored depending on the thickness of the polymer post-immersion in the first medium. Preferably, the electrically conductive cross-linked polymer is immersed in a second medium for a period of at least 1 minute, more preferably at least 10 minutes, more preferably at least 1 hour, more preferably at least 2 hours per mm thickness of polymer. After immersion in the second medium, the polymer can then be removed from the second medium.

Disclosed herein, the first medium and the second medium are both liquids. The term “liquid” takes its usual definition in the art and would be readily understood by the skilled person, and so refers to a substance that exists in liquid form at ambient temperature and pressure (i.e. at a temperature of 30° C. and a pressure of 1 bar).

Disclosed herein, the first medium comprises the electrically conductive nanoparticulate material dispersed in a non-aqueous polar liquid. Preferably, the amount of electrically conductive nanoparticulate material present in the first medium is in the range of 2-30 wt %, more preferably 2-10 wt % based on the total weight of the first medium.

The term “non-aqueous” when used in relation to the polar liquid means that the polar liquid is substantially free from water, more specifically that the polar liquid contains less than 10 wt % water, preferably less than 5 wt % water, more preferably less than 1 wt % water, or less than 0.5 wt % water, based on the total weight of the polar liquid. The polar liquid may comprise 0.1% or even 0% water.

As used herein, the term “polar” as used in relation to the polar liquid of the first medium refers to a liquid whose molecular constituents have a dipole moment due to the asymmetric distribution of electronic charge. The skilled person will be familiar with what substances constitute a non-aqueous polar liquid. One such measure of polarity is the dielectric constant. The dielectric constant can be measured using the method disclosed in CRC, Handbook of Chemistry and Physics (92nd Edition, 2011-2012, chapter entitled “Laboratory solvents and other liquid reagents”). A greater dielectric constant indicates a greater polarity (which can also be referred to as a greater dipole moment). Preferably, the non-aqueous polar liquid has a dielectric constant of at least 10, more preferably at least 15, more preferably at least 20.

Preferably, the non-aqueous polar liquid of the first medium is an alcohol. More preferably, the non-aqueous polar liquid of the first medium is methanol, ethanol, propanol, butanol, or mixtures thereof. Most preferably, the non-aqueous polar liquid of the first medium is ethanol. It is thought that immersion in ethanol results in particularly effective expansion of the polymer, thereby allowing particularly effective uptake of the nanoparticulate material.

Disclosed herein, after the step of immersing the electrically conductive cross-linked polymer in the first medium, there is the step of immersing the electrically conductive cross-linked polymer in a second medium. The second medium comprises an aqueous liquid. Preferably, the second medium consists of an aqueous liquid. The term “aqueous” when used in relation to the liquid of the second medium refers to a liquid that contains a significant proportion of water e.g. more than 50 wt % water, preferably more than 75 wt % water, more preferably more than 85% wt % water, based on the total weight of the liquid.

Preferably, the aqueous liquid of the second medium is distilled deionized water, an aqueous solution of saline, an aqueous solution of brine, an aqueous solution of acid, or an aqueous solution of alkali. More preferably, the second medium is an aqueous solution of acid. When saline solution is used, the saline solution preferably has 0.002 g/cc to 0.1 g/cc of NaCl in water, more preferably 0.009 g/cc of NaCl in water. When brine solution is used, the brine solution preferably has 0.3 g/cc of NaCl in water. When acid solution is used, the acid is preferably 5 mol/dm³ H₂SO₄. When alkali solution is used, the alkali solution is preferably an aqueous solution of KOH with the KOH is present at 10 wt % to 30 wt %.

Preferably, the process disclosed herein further comprises the step of hydrating the electrically conductive cross-linked polymer prior to the step of immersing the electrically conductive cross-linked polymer in the first medium. It is thought that this initial hydration step provides an initial expansion of the polymer, which contributes to the eventual uptake of the nanoparticulate material upon immersion in the first medium.

This hydration step is preferably carried out by immersion in a hydration medium that is an aqueous liquid. The hydration medium may be the same or different to the aqueous liquid of the second medium. Consequently, the aqueous liquid of the hydration medium may be distilled deionized water, an aqueous solution of saline, an aqueous solution of brine, an aqueous solution of acid, or an aqueous solution of alkali. Preferably, the second medium is distilled deionized water. When saline solution is used, the saline solution preferably has 0.002 g/cc to 0.1 g/cc of NaCl in water, more preferably 0.009 g/cc of NaCl in water. When brine solution is used, the brine solution preferably has 0.3 g/cc of NaCl in water. When acid solution is used, the acid is preferably 5 mol/dm³ H₂SO₄. When alkali solution is used, the alkali solution is preferably an aqueous solution of KOH with the KOH is present at 10 wt % to 30 wt %.

Preferably, the polymer is not immersed in the first medium, the second medium, or the hydration medium such that hydraulic equilibrium is reached, as preferably only one or more surface layers is affected by the ingress of liquid, rather than the entre bulk polymer. Nevertheless, the nature of the first medium is preferably such that, if the polymer were to be immersed such that hydraulic equilibrium is reached, the polymer would expand by at least 10%, preferably at least 50%, in any linear dimension. Preferably, the linear expansion ratio (as a ratio of the width of polymer post immersion in the first medium: the width of a polymer pre-immersion in the first medium) would be at least 1.4:1, more preferably at least 1.7:1, most preferably at least 1.8:1, if hydraulic equilibrium were to be reached. Similarly, the nature of the second medium is preferably such that, if the polymer were to be immersed such that hydraulic equilibrium is reached, the polymer would contract by at least 10% in any linear dimension, compared with the polymer size achieved by reaching hydraulic equilibrium in the first medium. Preferably, the linear expansion ratio (as a ratio of the width of polymer post immersion in the second medium : the width of the polymer pre-immersion in both the first and second mediums) would be at most 1.8:1, more preferably at most 1.6:1, most preferably at most 1.4:1, if hydraulic equilibrium were to be reached. Likewise, the nature of the hydration medium in the (optional) initial hydration step is such that, if the polymer were to be hydrated such that hydraulic equilibrium is reached, the linear expansion ratio (as a ratio of hydrated polymer width: the dry, non-hydrated polymer width) would be at least 1.2:1, more preferably at least 1.4:1, most preferably at least 1.6:1, and the amount of water in the polymer would be at least 40% by weight, preferably at least 50% by weight, more preferably at least 60% by weight, based on the total weight of the hydrated polymer, if hydraulic equilibrium were to be reached.

Disclosed herein is an electrically conductive cross-linked polymer containing an electrically conductive nanoparticulate material integrated in its surface layer, obtainable by the process disclosed herein. Preferred features such as nanoparticulate material, amounts, polymerisation mixtures and polymerisation conditions are disclosed above.

Also provided herein is a process of forming a supercapacitor, comprising the steps of integrating electrically conductive nanoparticulate material into a surface layer of an electrically conductive cross-linked polymer using the process disclosed herein, and positioning the resulting integrated polymer between two electrodes. The polymer is generally removed from the second medium before use in a supercapacitor. Provided herein is the use of the integrated polymer in a supercapacitor, and a supercapacitor comprising two electrodes and the integrated polymer located therebetween. By positioning/locating the integrated polymer between two electrodes such that the polymer contacts the electrodes, a polymer/electrode interface forms which acts as an effective extended surface area at the polymer/electrode interface. This provides increased capacitance without having to resort to extended surface area electrodes, and so allows increased capacitance to be achieved whilst using simple smooth surface electrodes.

Although the integrated polymers disclosed herein need not be used with non-smooth electrode surfaces, they are compatible with non-smooth surfaces. The effective surface area can be further increased by casting the electrically conductive cross-linked polymer against a suitably shaped surface to act as a mould during its formation, applying the process disclosed herein, and then matching the integrated polymer with a machined electrode of the same profile.

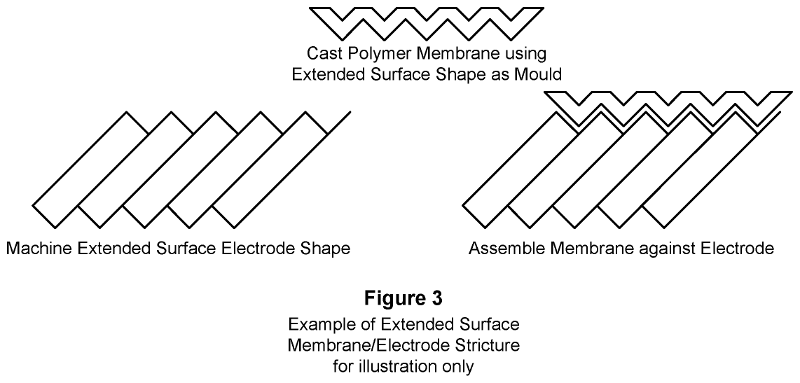

This is shown schematically in FIG. 3.

The following non-limiting examples illustrate the invention.

### EXAMPLES

The following abbreviations are used in these examples:

AN: acrylonitrile

VP: vinyl-2-pyrrolidone

PEDOT:PSS : polyethylenedioxythiophene:polystyrene sulphonate

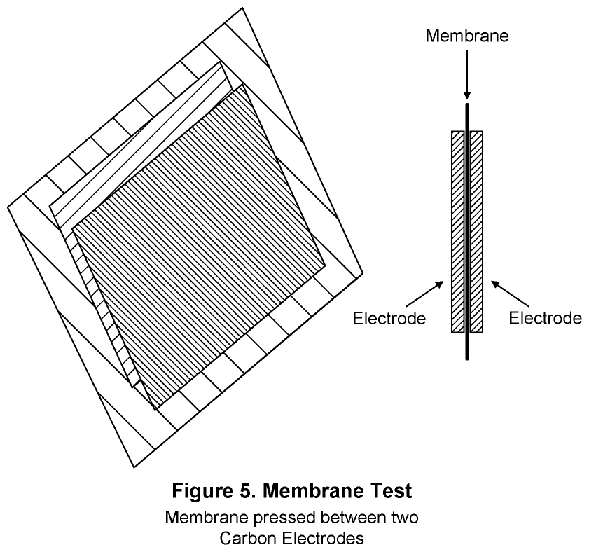

In these examples, capacitance was measured using a Sencore capacitance meter while the membrane was pressed between two smooth carbon electrode surfaces as shown in FIG. 5

### Example 1

An electrically conductive cross-linked polymer was formed with composition AN-VP-phenylalanine. This capacitance of this polymer “as formed” was measured.

This polymer was first hydrated by immersion in water. The hydrated polymer was then immersed in a dispersion of non-elongate carbon nanoparticles in ethanol, and then subsequently immersed in an aqueous solution of H2SO4.

The result was a polymer membrane where the carbon nanoparticles were entrapped i.e. integrated in its surface layer. The polymer membrane was washed in water, and only very small trace amounts of carbon particles were removed, and so it was concluded that the integrated nanoparticulate material is not easily removed by washing or ‘rubbing’ the surface.

The capacitance of the polymer with carbon nanoparticles integrated in its surface layer was measured.

The ratio of the capacitance per unit area for the integrated polymer to the polymer “as formed” was found to be 1.40:1. This represents an increase of 40% of capacitance for the integrated polymer.

### Example 2

An electrically conductive cross-linked polymer was formed with composition VP-PEDOT-AN.

This polymer was first hydrated in water by immersion in water. The hydrated polymer was then immersed in a dispersion of non-elongate carbon nanoparticles in ethanol, and then subsequently immersed in an aqueous solution of H2SO4.

The result was a polymer membrane where the carbon nanoparticles were entrapped i.e. integrated in its surface layer. The polymer membrane was washed in water, and only very small trace amounts of carbon particles were removed, and so it was concluded that the integrated nanoparticulate material is not easily removed by washing or ‘rubbing’ the surface.

The ratio of the capacitance per unit area for the integrated polymer to the polymer “as formed” was found to be 1.25-1.3:1. This represents an increase of 25 and 30% of capacitance for the integrated polymer.

1. A process of integrating electrically conductive nanoparticulate material into a surface layer of an electrically conductive cross-linked polymer, comprising the steps of:
immersing an electrically conductive cross-linked polymer in a first medium, and subsequently immersing the electrically conductive cross-linked polymer in a second medium; wherein
the first medium comprises an electrically conductive nanoparticulate material dispersed in a non-aqueous polar liquid, and
the second medium comprises an aqueous liquid.

2. The process of claim 1, further comprising the step of hydrating the electrically conductive cross-linked polymer prior to the step of immersing the electrically conductive cross-linked polymer in the first medium.

3. The process of claim 1, wherein the electrically conductive nanoparticulate material is electrically conductive carbon, a transition metal oxide, or combinations thereof.

4. The process of claim 3, wherein the transition metal oxide is MnO, MnO₂, NaMnO₂, ZnO₂, Fe₂O₃, MoS₂, V₂O₅, RuO₂, IrO₂, or combinations thereof.

5. The process of claim 3, wherein the electrically conductive carbon is in the form of activated carbon powder, powdered graphite, powdered graphene, powdered graphane, powdered carbon nanotubes, or combinations thereof.

6. The process of claim 1, wherein the electrically conductive nanoparticulate material consists of particles with an aspect ratio of from 2:1 to 100:1.

7. The process of claim 1, wherein the non-aqueous polar liquid of the first medium is methanol, ethanol, propanol, butanol, or mixtures thereof.

8. The process of claim 1, wherein the aqueous liquid of the second medium is distilled deionized water, an aqueous solution of saline, an aqueous solution of brine, an aqueous solution of acid, or an aqueous solution of alkali.

9. The process of claim 1, wherein the electrically conductive cross-linked polymer is hydrophilic.

10. The process of claim 1, wherein the electrically conductive cross-linked polymer is formed by polymerising a polymerisation mixture, the polymerisation mixture comprising at least one hydrophobic monomer, at least one hydrophilic monomer, and at least one cross-linker, the polymerisation mixture further comprising one or the other of at least one electronically conductive polymer, or at least one amino acid.

11. The process of claim 10, wherein the electrically conductive cross-linked polymer is formed by polymerising a polymerisation mixture, the polymerisation mixture comprising at least one hydrophobic monomer, at least one hydrophilic monomer, at least one electronically conductive polymer, and at least one cross-linker.

12. The process of claim 11, wherein the at least one electronically conductive polymer is selected from polyethylenedioxythiophene:polystyrene sulphonate, polypyrrole, polyaniline, polyacetylene, or a combination thereof.

13. The process of claim 10, wherein the electrically conductive cross-linked polymer is formed by polymerising a polymerisation mixture, the polymerisation mixture comprising at least one hydrophobic monomer, at least one hydrophilic monomer, at least one amino acid, and at least one cross-linker.

14. The process of claim 13, wherein the at least one amino acid is selected from phenylalanine, tryptophan, histidine, ethylenediaminetetraacetic acid (EDTA) and tyrosine, or a combination thereof

15. The process according to claim 10, wherein the at least one hydrophobic monomer is selected from methyl methacrylate, allyl methacrylate, acrylonitrile, methacryloxypropyltris(trimethylsiloxy)silane, 2,2,2-trifluoroethyl methacrylate, or a combination thereof.

16. The process according to claim 10, wherein the at least one hydrophilic monomer is selected from methacrylic acid, 2-hydroxyethyl methacrylate, ethyl acrylate, vinyl pyrrolidone, propenoic acid methyl ester, monomethacryloyloxyethyl phthalate, ammonium sulphatoethyl methacrylate, poly vinyl alcohol or a combination thereof.

17. The process according to claim 10, wherein the at least one cross-linker is allyl methacrylate, ethylene glycol dimethacrylate, or combinations thereof.

18. The process according to claim 10, wherein the polymerisation is carried out by thermal, UV or gamma radiation.

19. The process of any claim 10, wherein the electrically conductive nanoparticulate material is integrated into both of the top surface layer and the bottom surface layer of the electrically conductive cross-linked polymer.

20. A process of forming a supercapacitor, comprising the steps of: integrating electrically conductive nanoparticulate material into a surface layer of an electrically conductive cross-linked polymer using the process of claim 1; and positioning the polymer between two electrodes.

21. An electrically conductive cross-linked polymer containing an electrically conductive nanoparticulate material integrated in a surface layer, obtainable by the process according to claim 1.

22. An electrically conductive cross-linked polymer containing an electrically conductive nanoparticulate material integrated in a surface layer.

23. The electrically conductive cross-linked polymer of claim 21, wherein the electrically conductive nanoparticulate material is electrically conductive carbon, a transition metal oxide, or combinations thereof.

24. The electrically conductive cross-linked polymer of claim 23, wherein the transition metal oxide is MnO, MnO₂, NaMnO₂; ZnO₂; Fe₂O₃; MoS₂, V₂O₅, RuO₂, IrO₂, or combinations thereof.

25. The electrically conductive cross-linked polymer of claim 23, wherein the electrically conductive carbon is in the form of powdered activated carbon, powdered graphite, powdered graphene, powdered graphane, powdered carbon nanotubes, or combinations thereof.

26. The electrically conductive cross-linked polymer of claim 21, wherein the electrically conductive nanoparticulate material consists of particles with an aspect ratio of from 2:1 to 100:1.

27. Use of a polymer according to claim 21 in a supercapacitor.

28. A supercapacitor comprising two electrodes and a polymer according to claim 21 located therebetween.
